(19) United States
(12) Patent Application Publication
(10) Pub. No.: US 2013/0080334 A1
(43) Pub. Date: Mar. 28, 2013

(54) PAYMENT SYSTEM FOR HANDHELD DEVICE AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/332,475

(22) Filed: Dec. 21, 2011

(30) Foreign Application Priority Data
Sep. 28, 2011 (TW) 100135111

(51) Int. Cl. G06Q 20/40

(52) U.S. Cl. 705/76

(57) ABSTRACT

A payment method includes: inputting identity information and a password through a handheld device, comparing the identity information and the password through a host server to determine whether the customer is an authorized user, encrypting the identity information to generate authentication information, generating a barcode which includes the authentication information and a deadline for use, acquiring the barcode on the handheld device, decoding the barcode by a barcode reading unit of a point of sale device, inputting a price the customer wants to pay, decrypting the authentication information to obtain the identity information, comparing the identity information decrypted to determine whether the identity information is correct, and transmitting a success notification to the point of sale device for indicating that the payment is completed.

### BACKGROUND

1. Technical Field

The present disclosure relates to a payment system and a payment method with a handheld device.

2. Description of Related Art

“Mobile cash” means that consumers can pay bills using a mobile phone. To use the mobile cash, the consumers need to exchange their subscriber identity module (SIM) cards set in the mobile phones for radio-frequency identification (RFID) and SIM cards, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an exemplary embodiment of a payment system, wherein the payment system includes a handheld device, a host server, and a bill counting device.

FIG. 2 is a block diagram of the handheld device of FIG. 1.

FIG. 3 is a block diagram of the host server of FIG. 1.

FIG. 4 is a block diagram of the bill counting device of FIG. 1.

FIGS. 5A and 5B are flowcharts of an exemplary embodiment of a payment method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

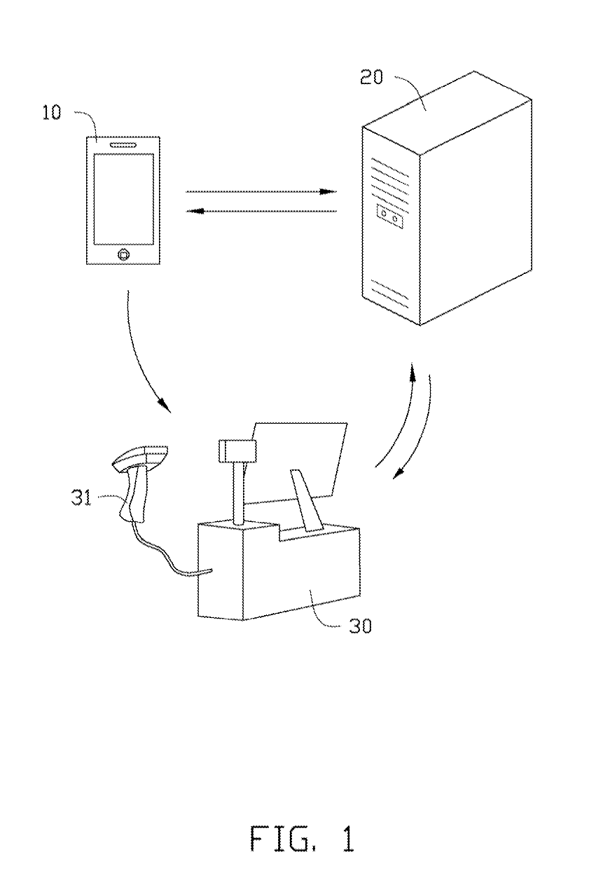

Referring to FIG. 1, an exemplary embodiment of a payment system includes a handheld device 10, a host server 20, and a point of sale device 30. In this embodiment, the handheld device 10 is a mobile phone which can communicate with the host server 20. The host server 20 may belong to a telecom operator. The point of sale device 30 can communicate with the host server 20 with wires or wireless, such as Bluetooth.

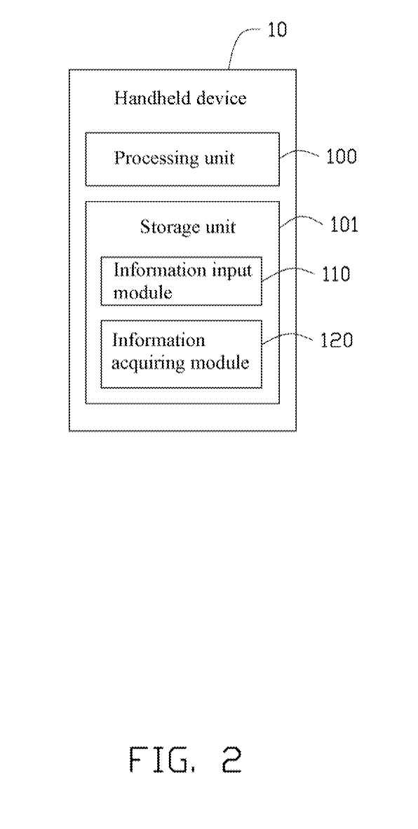

Referring to FIG. 2, a processing unit 100 and a storage unit 101 are present in the handheld device 10. The storage unit 101 includes an information input module 110 and an information acquiring module 120, which may include computer code to be executed by the processing unit 100.

The information input module 110 records and transmits information as to the identity of a user (identity information) and a password for authenticating the customer as an authorized user. The information acquiring module 120 requests a barcode from the host server 20 when the identity information and the password are verified.

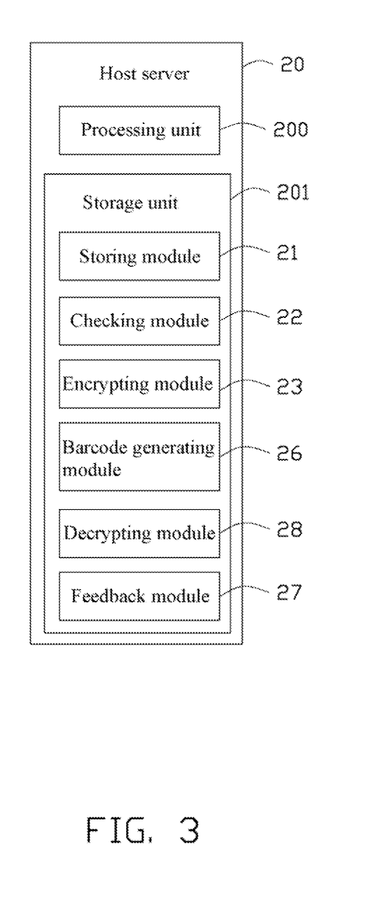

Referring to FIG. 3, a processing unit 200 and a storage unit 201 are present in the host server 20. The storage unit 201 includes a storing module 21, a checking module 22, an encrypting module 23, a barcode generating module 26, a decrypting module 28, and a feedback module 27, which may include computer code to be executed by the processing unit 200.

The storing module 21 stores information concerning a plurality of customers. The information concerning the customers includes identity information, the password, and the credit limit of each customer. When the user inputs his identity information and the password through the information input module 110, the handheld device 10 transmits the identity information and the password to the host server 20.

The checking module 22 compares the identity information and the password received with the identity information and the passwords stored in the storing module 21 to determine whether the customer is an authorized user. When the checking module 22 has determined that the customer is an authorized user, the information acquiring module 120 may request and receive a barcode from the host server 20. The encrypting module 23 encrypts the identity information from the information input module 110, and the current time, to generate authentication information. The authentication information also includes a deadline, such as five minutes after encryption. The barcode generating module 26 generates a barcode which includes the authentication information, and transmits the barcode to the handheld device 10. The handheld device 10 shows the barcode on a screen of the handheld device 10.

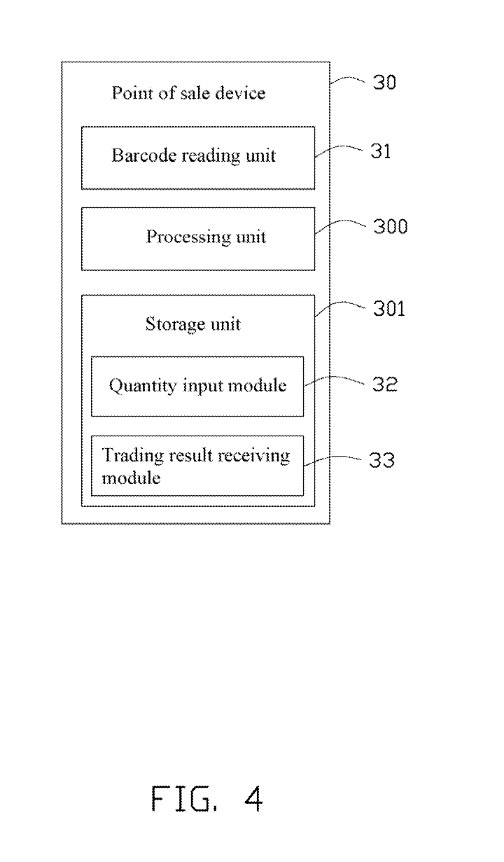

Referring to FIG. 4, the point of sale device 30 includes a barcode reading unit 31, a processing unit 300, and a storage unit 301. The storage unit 301 includes a quantity input module 32 and a trading result receiving module 33, which may include computer code to be executed by the processing unit 300. The barcode reading unit 31 reads the barcode displayed on the screen of the handheld device 10, and can decode the barcode to obtain the encrypted authentication information.

The quantity input module 32 inputs a price the customer wants to pay. The authentication information and the price are transmitted to the decrypting module 28. The decrypting module 28 decrypts the decoded authentication information to obtain the identity information and the deadline. The checking module 22 compares the identity information with the identity information stored in the storing module 21 to determine whether the identity information is correct. The checking module 22 further determines whether the authentication information has expired according to the deadline. If the identity information is correct and the authentication information has not expired, the checking module 22 further determines whether the price to be paid will exceed the credit limit corresponding to the identity information of that customer. If the credit limit will not be exceeded by the price, the feedback module 27 transmits a success notification to the trading result receiving module 33 for indicating that the transaction can be completed.

The host server 20 records the price(s) paid by each user over a period of time, and sends the customer or user a credit bill including expenses for the sum of prices paid during the period of time. After payment of the credit bill, the telecom operator pays money to the store or other organization operating the point of sale device 30.

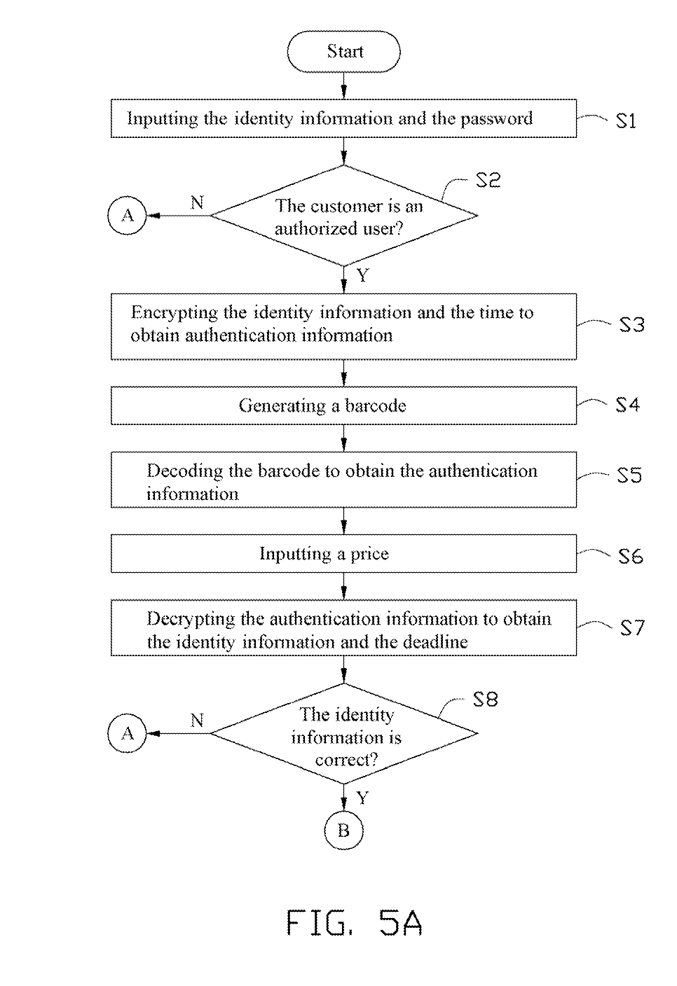

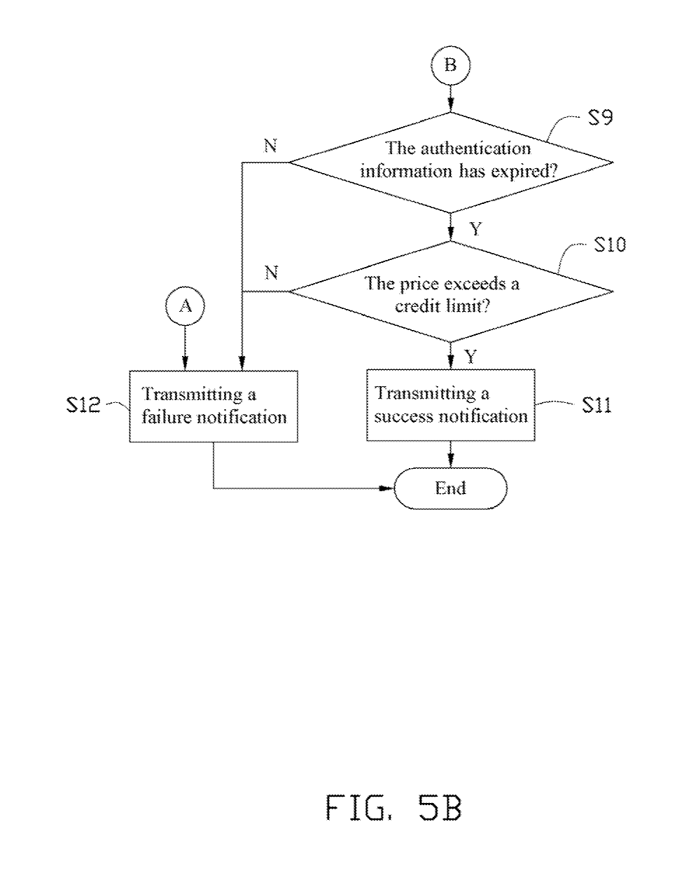

Referring to FIGS. 5A and 5B, an exemplary embodiment of a payment method includes the following steps.

In step S1, the recorded identity information and the password are input through the information input module 110.

In step S2, the checking module 22 compares the identity information and the password input through the information input module 110 with the identity information and the passwords stored in the storing module 21 to determine whether the user is an authorized user. If the user is authorized, the process flows to step S3. If the user is not authorized, the method flows to step S12.

In step S3, the encrypting module 23 encrypts the identity information received and notes the current time to generate authentication information. The authentication information further includes a user deadline, such as five minutes after encryption.

In step S4, the barcode generating module 26 generates a barcode which includes the authentication information, and transmits the barcode to the handheld device 10.

In step S5, the barcode reading unit 31 reads the barcode displayed on the screen of the handheld device 10, and decodes the barcode to obtain the encrypted authentication information.

In step S6, a price which the customer wants to pay is input through the quantity input module 32.

In step S7, the decrypting module 28 decrypts the decoded authentication information to obtain the identity information and the user deadline.

In step S8, the checking module 22 compares the identity information from the decrypting module 28 with the identity information stored in the storing module 21 to determine whether the identity information is correct. If the identity information is correct, the process flows to step S9. If the identity information is incorrect, the process proceeds to step S12.

In step S9, the checking module 22 determines whether the authentication information is valid, or has expired according to the deadline. If the authentication information is still valid, the process flows to step S10. If the authentication information is no longer valid, the process flows to step S12.

In step S10, the checking module 22 determines whether the price would exceed the credit limit corresponding to the identity information of that customer. If the price is within the credit limit, the process continues to step S11. If the price exceeds the limit, the method flows to step S12.

In step S11, the feedback module 27 transmits a success notification to the trading result receiving module 33 to indicate that the transaction is completed.

In step S12, the feedback module 27 transmits a failure notification to the trading result receiving module 33 to indicate that the payment has not been made.

The host server 20 records the price(s) paid by each user over a period of time, and sends the user a bill including expenses for the sum of prices paid during the period of time. After payment of the credit bill, the telecom operator pays out money to the store or other organization operating the point of sale device 30.

The foregoing description of the embodiment of the disclosure has been presented only for the purposes of illustration and description and is not intended to be exhaustive or to limit the disclosure to the precise form(s) disclosed. Many modifications and variations are possible in light of everything above. The embodiment was chosen and described in order to explain the principles of the disclosure and practical application of it so as to enable others of ordinary skill in the art to utilize the disclosure and embodiment(s) with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the embodiment(s) described therein.

What is claimed is:

1. A payment system comprising:
a handheld device comprising:
a first processing unit; and
a first storage unit connected to the first processing unit and storing a plurality of programs to be executed by the first processing unit, wherein the first storage unit comprises:
an information input module to input identity information and a password; and
an information acquiring module;
a host server comprising:
a second processing unit; and
a second storage unit connected to the second processing unit and storing a plurality of programs to be executed by the second processing unit, wherein the second storage unit comprises:
a storing module to store information concerning a plurality of customers, wherein the information of the customers comprises the identity information and the password;
a checking module to compare the identity information and the password inputted through the information input module with the identity information and the passwords stored in the storing module to determine whether the customer is an authorized user;
an encrypting module to encrypt the identity information to obtain authentication information when the customer is an authorized user;
a barcode generating module to generate a barcode comprising the authentication information, wherein the information acquirement module acquires the barcode; and
a feedback module; and
a point of sale device comprising:
a barcode reading unit to read the barcode displayed on the handheld device and decode the barcode to obtain the authentication information;
a third processing unit; and
a third storage unit connected to the processing unit and storing a plurality of programs to be executed by the third processing unit, wherein the third storage unit comprises:
a quantity input module to input a price the customer wants to pay;
a decrypting module to decrypt the authentication information to obtain the identity information, wherein the checking module further compares the identity information with the identity information stored in the storing module to determine whether the identity information is correct; and
a trading result receiving module, wherein the feedback module transmits a success notification to the trading result receiving module for indicating that the payment is completed when the identity information is correct.

2. The payment system of claim 1, wherein the information stored in the storing module further comprises a credit limit of each customer, the checking module further determines whether the price input through the quantity input module exceeds the credit limit corresponding to the identity information when the identity information is correct.

3. The payment system of claim 1, wherein the authentication information further comprises a deadline, the decrypting module further decrypts the authentication information to obtain the deadline, the checking module further determines whether the authentication information has expired according to the deadline.

4. A payment method comprising:
recording identity information and a password through a handheld device;
comparing the identity information and the password through a host server to determine whether the customer is an authorized user;
encrypting the identity information to obtain authentication information through the host server;
generating a barcode which includes the authentication information through the host server;
acquiring the barcode from the host server through the handheld device;
reading the barcode on the handheld device, and decoding the barcode to obtain the authentication information through a barcode reading unit of a point of sale device;
inputting a price the customer wants to pay through the point of sale device;
decrypting the authentication information to obtain the identity information through the host server;
comparing the identity information decrypted to determine whether the identity information is correct through the host server; and
transmitting a success notification to the point of sale device for indicating that the payment is completed.

5. The payment method of claim 4, further comprising:
determining whether the price input through the point of sale device exceeds the credit limit corresponding to the identity information when the identity information is correct.

6. The payment method of claim 4, wherein the authentication information further comprises a deadline, the payment method further comprises:
determining whether the authentication information has expired according to the deadline.
